(19) United States
(12) Patent Application Publication
(10) Pub. No.: US 2025/0084755 A1
(43) Pub. Date: Mar. 13, 2025

(54) AUTOMATED DISCOVERY AND CONFIGURATION OF HYDROCARBON WELL FIELD DEVICES

(71) Applicant: Halliburton Energy Services, Inc., Houston, TX (US)

(72) Inventors: Karl Kristian Olsen, Stavanger (NO); Kamil Antosz, Stavanger (NO); Oddbjørn Kvammen, Stavanger (NO); Ketankumar M. Chokshi, San Diego, CA (US); Kevin Vander Wyst, New Caney, TX (US); Frode Samuelsen, Tananger (NO)

(21) Appl. No.: 18/462,840

(22) Filed: Sep. 7, 2023

(51) Int. Cl. E21B 47/008; G06Q 10/087

(52) U.S. Cl. CPC E21B 47/008; G06Q 10/087; E21B 2200/20

(57) ABSTRACT

A system for discovering and remotely configuring each of a plurality of field devices used in a hydrocarbon well drilling or production operation. Field data and metadata are transmitted by each field device of the plurality of field devices. In an example, the field data may be measurement data, and the metadata may be identifying information, operating parameters or characteristics, or other information about the field devices. A computing device of the system may automatically discover new field devices and can retrieve from one or more sources, field device specifications for each field device that can be used to calibrate or otherwise configure the field device. Subsequent to discovery and configuration of the field devices, the system may monitor operation of the field devices and report any operational faults.

### TECHNICAL FIELD

The present disclosure relates generally to hydrocarbon well operations, and more particularly although not necessarily exclusively, to the automatic detection and configuration of field devices used with various types of hydrocarbon well drilling and production equipment.

### BACKGROUND

Subsurface and subsea hydrocarbon well drilling and production operations are complex processes, requiring a multitude of unique equipment. This equipment typically includes for example, field devices such as but not limited to various types of sensors that may be employed for different monitoring, detection, reporting, and other purposes. The process of configuring all the field devices of a given subsurface or subsea hydrocarbon well drilling or production operation in a traditional manner can require months to complete because, for example, each device must be individually configured at the device location, and the device locations are frequently hazardous locations that may require personnel performing a configuration operation to carry a gas monitor or other safety equipment or to obtain permits prior to location entry. On-location configuration of field devices can also conflict with other drill site proceedings such as the installation of other equipment or actual drilling or production operations. This commonly results in the need for complicated scheduling considerations and, even then, only scant time is frequently available to perform a given field device configuration procedure.

Once a given field device has been configured on location, the field device must also be set up through software relative to the hardware controller or controllers that receive information from the field device, as well as relative to the overall control system associated with the drilling or production operation. And, even after such a time consuming configuration and setup process, the amount of remotely available information from each field device is typically very limited. Consequently, when more detailed (e.g., diagnostic) information is needed, a physical visit to the field device of interest and a manual data extraction procedure is commonly required, and may further necessitate temporary storage and transfer of the extracted data to the field instrument vendor for analysis.

### BRIEF DESCRIPTION OF THE DRAWINGS

FIG. 1 is a schematic diagram of a hydrocarbon well drilling operation according to one example of the present disclosure.

FIG. 2 is a system diagram representing a topology and methodology for automatically detecting and configuring the field devices of a hydrocarbon well operation according to one example of the present disclosure.

FIG. 3 is a block diagram of a computing device for automatically detecting and configuring the field devices of a hydrocarbon well operation according to one example of the present disclosure.

FIG. 4 is a flow chart representing a method for automatically detecting and configuring the field devices of a hydrocarbon well operation according to one example of the present disclosure.

### DETAILED DESCRIPTION

Certain aspects and examples of the present disclosure relate to a system for automatically discovering and remotely configuring a plurality of field devices in a hydrocarbon well drilling or production operation, thereby eliminating the current time consuming process of configuring such field devices on location. The field devices may be, for example, various types of smart sensors, such as but not limited to, sensors for monitoring pressure, temperature, fluid levels, flow rates, vibrations, or the presence of hazardous gases or other substances. Such field devices can be associated with a multitude of different hydrocarbon well drilling or production equipment including, for example and without limitation, well bores, well heads, pipelines and other flowlines, engines, and compressors.

The field devices may also be configured to transmit field device data and metadata about the plurality of field devices to a computing device, such as to a communication subsystem of the computing device, via one or more communication mediums. The computing device may execute instructions that cause the computing device to automatically discover the plurality of field devices and remotely configure each field device in an initial calibration process based on specifications of the plurality of field devices. Using the field device data and the metadata, the computing device can determine expected performance characteristics of each field device, can compare subsequently receive data from a given field device to the expected performance characteristics for the given field, and if indicated by the results of the comparison, can output a command to remotely reconfigure the given field device or to generating a notification identifying a problem with the given field device.

Illustrative examples follow, and are given to introduce the reader to the general subject matter discussed herein rather than to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

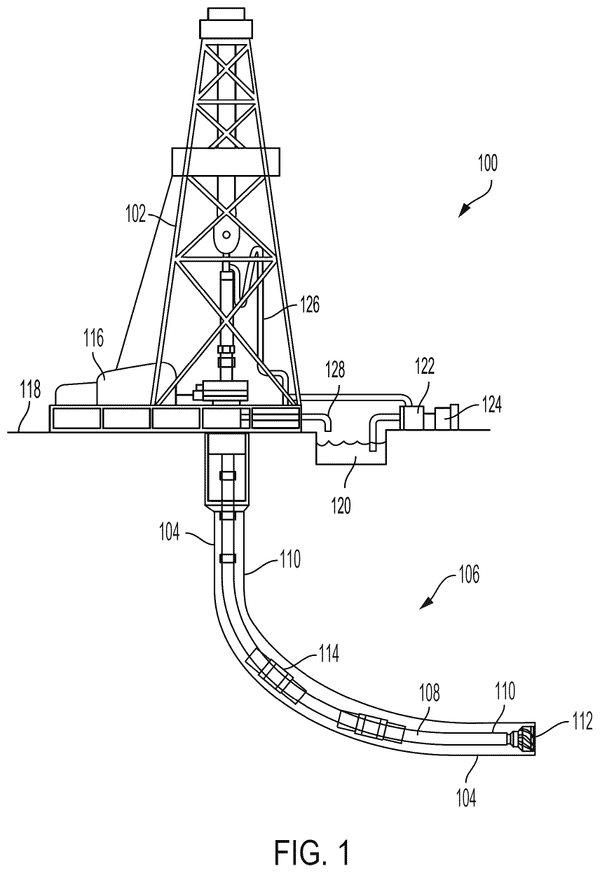

One example of a hydrocarbon well drilling system 100 is represented in the diagram of FIG. 1. As shown, the hydrocarbon well drilling system 100 can include a derrick 102 used to drill a wellbore 104 into a subterranean formation 106. Drilling of the wellbore 104 in this example is accomplished through use of a drill string 108, which is suspended from the derrick 102 and includes a bottom hole assembly 110. A drill bit 112 is associated with the bottom hole assembly 110, which may be moved axially within the wellbore 104 and may include one or more tool joints 114. The drill bit 112 can be rotated using a downhole motor or by rotation of the drill string 108 via electric or hydraulic motors 116 positioned at the surface 118.

During the wellbore drilling operation, drilling fluid (“mud”) from a mud tank 120 can be pumped downhole using a mud pump 122 driven by a prime mover such as a motor 124. The drilling fluid from the mud tank 120 may be pumped into the drill string 108 through a standpipe 126, where it is thereafter conveyed to the drill bit 112 to effectuate the cooling thereof. Drilling fluid that exits the drill bit 112 circulates back to the surface 118 via an annulus defined between the wellbore 104 and the drill string 108. Upon reaching the surface 118, the drilling fluid passes through a flow line 128 and is thereafter processed to remove cuttings, etc., such that clean drilling fluid is returned to the mud tank 120 for subsequent pumping back down hole through the standpipe 126. Field devices may be utilized by the hydrocarbon well drilling system 100 to measure, for example and without limitation, drilling fluid and other fluid pressures, various fluid or device temperatures, mud tank or other fluid levels, drilling fluid and other fluid flow rates, engine, motor, or pump vibrations, or the presence of hazardous gases or other dangerous substances at various areas of the frill site.

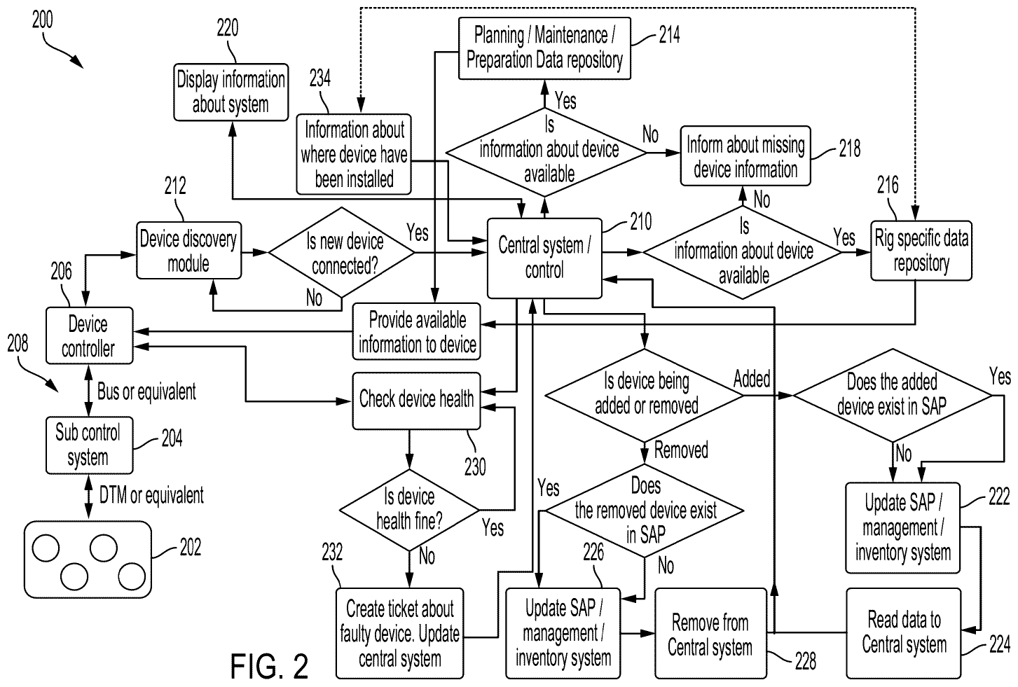

FIG. 2 is a system diagram representing one example of a system 200 topology and methodology for automatically detecting and configuring the field devices of a hydrocarbon well operation, such as, but not limited to, the hydrocarbon well drilling operation illustrated in FIG. 1. Similar topologies and methodologies can also be used relative to other hydrocarbon well operations, such as for example, hydrocarbon production wells. Further, while FIG. 2 depicts the system 200 as including certain components, other examples may involve more, fewer, or different components than are shown in FIG. 2.

As indicated in FIG. 2, the system 200 includes a plurality of field devices 202 that are positioned at a hydrocarbon well drilling location. The field devices may be, for example, various types of smart sensors, such as but not limited to, sensors for monitoring pressure, temperature, fluid levels, flow rates, vibrations, or the presence of hazardous gases or other substances. Such field devices can be associated with a multitude of different hydrocarbon well drilling or production equipment including, for example and without limitation, well bores, well heads, pipelines and other flowlines, engines, and compressors.

As should be understood by one of skill in the art, when the field devices 202 are smart sensors or similar devices, the field devices will typically include a built-in processor and communication capabilities (e.g., a transceiver). Such a field device may be configured to transmit data to a computing device via one or more communication mediums. The data can include field device data (e.g., measurement data), metadata about the field device, or both.

In the example of FIG. 2, the plurality of field devices are communicatively coupled to a communication subsystem 204 located at the well site. The communication subsystem 204 can be, for example, a remote I/O module, a controller, etc. The communication subsystem 204 may also include a barrier that has explosion-proof properties and may perform signal conversion operations on signals received from the field devices 202. The communication subsystem 204 can be an active system, which may include a barrier with an active controller, or a passive system, such as a barrier with a passive controller that is operated from a remotely located active controller such as a PLC, a SBC, a PC, etc.

In the example of FIG. 2, field device data and metadata is transmitted through the communication subsystem 204 to a local field device controller 206 via a fieldbus 208 or another suitable communication medium. The fieldbus 208 may be, for example and without limitation, a Modbus, Profibus, Ethernet/IP, or another bus type that is appropriate based on the field device communications. The field device controller 206 may be, for example, a software-based controller running on a personal computer, a laptop computer, etc.

In another example of the system 200 according to the present disclosure, field device data and metadata may be wirelessly communicated by the plurality of field devices 202. In such an example, the local barrier described above can be replaced with a remote barrier.

The system 200 can include a computing device 210 that is operative to discover new field devices 202 that are added to the system, to configure new field devices or reconfigure existing field devices, and to monitor the field devices 202 of the system 200. As described in more detail below, the computing device 210 may include a processor and a non-transitory computer-readable medium having program code stored thereon that is executable by the processor for causing the processor to perform various operations related to automatic detection and configuration of the field devices 202. The computing device 210 can be located at the well site, or may reside at a location remote from the well site. In system examples according to the present disclosure, the computing device 210 may be, without limitation, a local computing device, a distributed computing device, or a server-based client computing system. The computing device 210 may also be a component of a computing system that can also include the communication subsystem 204.

In the system 200 example of FIG. 2, the computing device 210 may discover new field devices 202 using a device discovery module 212 that can continuously or periodically scan the system. A field device 202 may be considered new relative to the system 200 when the added field device was not previously a part of the system 200 or when the added field device is a replacement for a field device that was already present, such as due to replacement of a previously existing faulty field device. When the device discovery module 212 detects a new field device 202 and reports the same to the computing device 210, the computing device 210 can, such as through the device discovery module 212, query the new field device 202 for data (e.g., metadata). The data available from a new field device (or an existing field device) can vary, and may, for example, include any or all the information typically provided in a field device data sheet. For example, the data can include but is not necessarily limited to, identification information such as the device name and version, a device serial number, a device description, and the vendor name, various device parameters such as the power supply wiring type, device address, and software version, units of measurement, min/max adjustment capacity, application type (e.g., liquids), damping information, linearization information, display information, scaling information, and other information as may be determined by the nature of the field device and/or the manufacturer of the field device. The computing device 210 may also determine from information stored at the new field device 202, whether the new field device 202 is already calibrated. The metadata retrieved from a field device 202 can be stored by the computing device 210, either at the computing device 210 or in one or more local or remotely located data repositories.

Although only described above as occurring relative to initial configuration of new field device 202, the computing device 210 in examples of the system 200 according to the present disclosure can at any time retrieve from a new (or an existing) field device 202 any or all of the data stored on the field device 202, although repeated transmission of all the field device information stored at the field device may be inadvisable to minimize required communication bandwidth. Each item of data stored at a field device 202 may include its own address to facilitate selective data retrieval by the computing device 210.

Once the computing device 210 has been notified by the device discovery module 212 of the presence of a new field device 202 and has retrieved metadata from the new field device 202, the computing device 210 can also determine whether other data regarding the new field device 202 is available. For example, the computing device 210 can use the serial number or other identifying information associated with the new field device 202 to determine the availability of calibration or other configuration data associated with the new field device 202.

As indicated in FIG. 2, the computing device 210 may query various sources, such as multiple data repositories, for field device configuration data or other data not stored at a field device of interest. In the system 200 example of FIG. 2, the multiple data repositories include a planning/maintenance/preparation data repository 214 and a (drilling) site specific data repository 216, but the number and type of data sources from which the computing device 210 may request field device data may be different in other examples of the system 200 according to the present disclosure. One or both of the data repositories 214, 216 can be a local database, or one or both of the data repositories 214, 216 can be a remotely located database. Additionally, one or both of the data repositories 214, 216 may be a cloud-based data repository. In another example of the system 200 according to the present disclosure, the computing device 210 may download specifications for a given field device 202 from a website or other online repository of the manufacturer of the field device 202 or from some other online information source. In still another example of the system 200 according to the present disclosure, the computing device 210 may retrieve specifications for a given field device 202 from a computer-readable flash memory device or another type of computer-readable medium on which the field device specifications are stored.

When the computing device 210 determines, as a result of a query, that no configuration, etc., data is available for a new field device 202, the computing device 210 may generate a notification 218 indicating the same. The notification 218 may be presented on a display 220 or may take the form of a message that is transmitted to another system or to certain personnel.

When the computing device 210 determines, as a result of a query, that additional data about a new field device 202 is available in one or both of the data repositories 214, 216, the computing device 210 can extract some or all the data from one or both of the data repositories 214, 216 and provide the data to the new field device 202, such as by transmitting the data to the field device controller 206. For example, the computing device 210 may retrieve calibration data for the new field device 202 from one or both of the data repositories 214, 216 and may effectuate calibration of the new field device 202 by causing the field device controller 206 to load the calibration data into the new field device 202. A recalibration of an existing field device 202 may be similarly accomplished. In this manner, the computing device 210 can remotely configure at least one performance attribute of each field device of the plurality of field devices 202 in an initial calibration process that uses specifications of the plurality of field devices.

Once a new field device 202 has been reported to and registered by the computing device 210, the computing device 210 can also update one or more other systems, such as but not limited to, related well operation planning, management, or inventory systems. For example, when the computing device 210 determines that a new field device 202 is being added or has been added to the system 200, the computing device 210 can determine whether the new field device 202 exists in one or more of a related planning, management, or inventory system 222, and can output a command that causes the planning, management, or inventory system 222 to be updated accordingly. For example, an inventory record of an inventory management system can be updated to indicate that the new field device 202 is now in use. Updated data from the planning, management, or inventory system 222 can then be transmitted 224 to the computing device 210. Similarly, when the computing device 210 determines that a field device 202 already known to the computing device 210 is being or has been removed from the system 200, the computing device 210 can also determine whether the field device 202 exists in one or more of the related planning, management, or inventory systems 222, and can output a command that causes the planning, management, or inventory system 222 to be updated accordingly. The field device 202 can then be removed 228 from the plurality of other field devices 202 being monitored by the computing device 210.

As mentioned above, subsequent to discovering new field devices 202 and calibrating or otherwise configuring the new field devices 202 (or ensuring the new field devices 202 are already calibrated), the computing device 210 can receive measurement data from the field devices 202 and can monitor operating characteristics of each field device of the plurality of field devices 202. As such, at least discovery, calibration, and monitoring functions relative to each field device of the plurality of field devices are under centralized control of the computing device 210.

Field device data can be used by the computing device 210 for a number of purposes, such as without limitation, controlling various drilling, pumping, or other processes associated with a drilling or production well operation. Likewise, the computing device 210 can use the field device data and metadata to determine expected performance characteristics of each field device of the plurality of field devices 202. And, by comparing subsequently received field device data from at least one field device of the plurality of field devices 202 to the expected performance characteristics of the at least one field device of the plurality of field devices 202, the computing device 210 can determine whether the at least one field device is operating properly (i.e., is healthy) 230. This process can be repeated for each field device of the plurality of field devices 202. Based on the result of comparing the subsequently received field device data to the expected performance characteristics, the computing device 210 can also output a command to remotely reconfigure the at least one field device of the plurality of field devices or to generate a notification 232 identifying a problem with the at least one field device.

At least for purposes of monitoring field device health and the operations associated with received device measurement data, the computing device 210 may further receive other information 234 about each field device of the plurality of field devices 202. For example, as indicated in FIG. 2, the computing device 210 may receive process-related data from the site specific data repository 216. The process-related data may include, by way of example and not limitation, expected field device measurement values such as fluid level, pressure, or temperature. The process-related data may also include information identifying the location of installation of each field device of the plurality of field devices 202. The computing device 210 may also store process-related or location identifying information about or from each field device of the plurality of field devices 202 to the site specific data repository 216.

A system according to an example of the present disclosure may utilize semantic modeling techniques whereby, for example, one or more of the components or operations of the system 200 of FIG. 2 may be replaced with one or more semantic models. Semantic modeling may enhance the operation and efficiency of the system 200. For example, by including semantic descriptions in the field device metadata, the process of discovering new field devices may be improved, and sensor communications may become more efficient as logical groupings or other associations between related sensors may be more apparent and may be effectuated automatically, as may communications with related systems.

A system according to an example of the present disclosure may also utilize artificial intelligence (AI), either with or without the use of semantic modeling. The use of AI in a system example according to the present disclosure may have numerous advantages, such as but not limited to, identifying field devices, predicting problems with field devices, or developing predictive maintenance schedules. In one non-limiting example, AI may be used to predict, such as based on signals from a given field device, the field device type and its likely function. In another non-limiting example, AI may be used to predict a forthcoming problem with a given field device based on data associated with a problem experienced by one or more other field devices belonging to the same group or family as the given field device. In another non-limiting example, AI may be used to predict, from data such as a higher frequency of maintenance visits to a first field device associated with a process at one location versus the number of maintenance visits made to a like second field device associated with a like process at another location, and from the location of the first field device, that the first field device is being affected by excessive dust build up, splashing of a liquid, or some other extraneous activity that is detrimentally affecting the performance of the first field device. An output of the AI may then be a maintenance schedule of increased frequency that is predicted to prevent the problem.

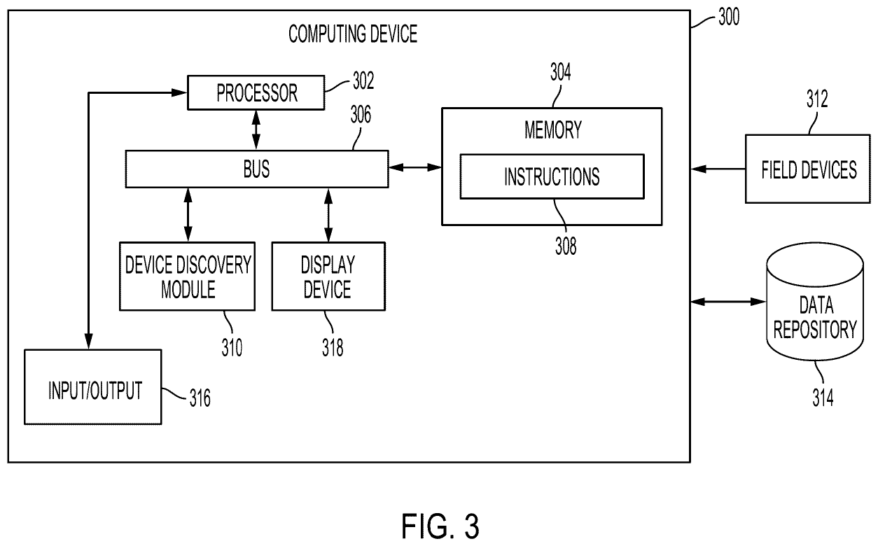

FIG. 3 is a block diagram of a computing device 300 that may be used in a system for automatically detecting, configuring, and monitoring the field devices of a hydrocarbon well operation. While FIG. 3 depicts the computing device 300 as including certain components, other examples may involve more, fewer, or different components than are shown in FIG. 3.

As shown, the computing device 300 includes a processor 302 communicatively coupled to a memory 304 by a bus 306. The processor 302 can include one processor or multiple processors. Non-limiting examples of the processor 302 include a Field-Programmable Gate Array (FPGA), an application specific integrated circuit (ASIC), a microprocessor, or any combination of these. Instructions 308 may be stored in the memory 304. The instructions are executable by the processor 302 for causing the processor 302 to perform various operations. In some examples, the instructions 308 can include processor specific instructions generated by a compiler or an interpreter from code written in any suitable computer-programming language, such as C, C++, C#, or Java.

The memory 304 can include one memory device or multiple memory devices. The memory 304 can be non-volatile and may include any type of memory device that retains stored information when powered off. Non-limiting examples of the memory 304 include electrically erasable and programmable read-only memory (EEPROM), flash memory, or any other type of non-volatile memory. At least some of the memory device includes a non-transitory computer-readable medium from which the processor 302 can read instructions 308. A non-transitory computer-readable medium can include electronic, optical, magnetic, or other storage devices capable of providing the processor 302 with the instructions 308 or other program code. Non-limiting examples of a non-transitory computer-readable medium include magnetic disk(s), memory chip(s), ROM, random-access memory (RAM), an ASIC, a configured processor, optical storage, or any other medium from which a computer processor can read the instructions 308.

Through the instructions 308, the processor 302 may cause a device discovery module 310 to operate as described above relative to detecting and reporting a new field device of a plurality of field devices 312 installed to a hydrocarbon well site. Using specifications retrieved from the field devices 312 and/or from a data repository, execution of the instructions 308 can also cause the processor 302 to perform various other operations, including remotely configuring at least one performance attribute of each field device of the plurality of field devices in an initial calibration process that uses specifications of the plurality of field devices, determining expected performance characteristics of each field device of the plurality of field devices using at least the metadata received from the field devices 312 by a communication subsystem, comparing subsequently received field device data from at least one field device of the plurality of field devices to expected performance characteristics of the at least one field device of the plurality of field devices.

In response to a result of comparing the subsequently received field device data to the expected performance characteristics, the processor 302 may also generate an output 316 in the form of a command to remotely reconfigure the at least one field device of the plurality of field devices. The output 316 of the processor 302 can instead or also be the generation of a notification identifying a problem with the at least one field device. At least when the output is a notification, the output can be presented via various mediums, including on a display device 318 communicatively coupled to the processor 302 by the bus 306. The output 316 of the processor 302 may also include a command that causes a physical action, such as but not limited to, an activation or deactivation of one or more of the field devices 312.

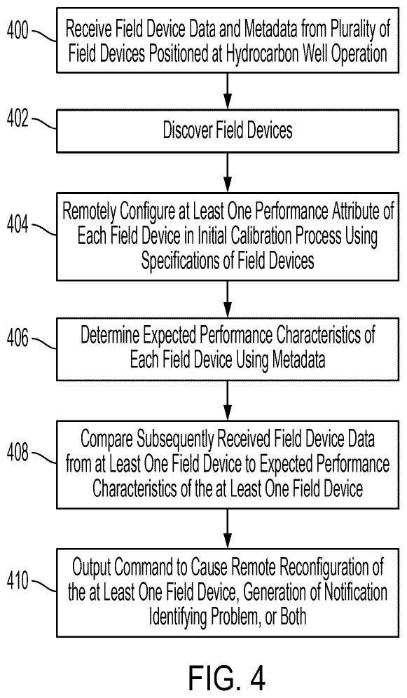

FIG. 4 is a flowchart representing a method of automatically discovering and configuring a plurality of field devices associated with a hydrocarbon well operation, according to one example of the present disclosure. As represented in FIG. 4, at block 400, a processor receives from a communication subsystem, field device data and metadata about a plurality of field devices positioned at a hydrocarbon well location, where the field device data and metadata are transmitted by the plurality of field devices via one or more communication mediums. At block 402, the processor discovers the plurality of field devices. At block 404, the processor remotely configures at least one performance attribute of each field device of the plurality of field devices in an initial calibration process that uses specifications of the plurality of field devices. At block 406, the processor then determines, using at least the metadata, expected performance characteristics of each field device of the plurality of field devices, and compares, at block 408, subsequently received field device data from at least one field device of the plurality of field devices to expected performance characteristics of the at least one field device of the plurality of field devices. In response to a result of comparing the subsequently received field device data to the expected performance characteristics, the processor can, at block 410, output a command to cause an action, such as an action selected from the group consisting of remotely reconfiguring the at least one field device of the plurality of field devices, generating a notification identifying a problem with the at least one field device, and a combination thereof.

According to aspects of the present disclosure, a system, a non-transitory computer-readable medium, and a method, are provided according to one or more of the following examples. As used below, any reference to a series of examples is to be understood as a reference to each of those examples disjunctively (e.g., “Examples 1-4” is to be understood as “Examples 1, 2, 3, or 4”).

Example 1 is a system, comprising: a plurality of field devices positioned at a hydrocarbon well location, the plurality of field devices positionable to transmit field device data and metadata about the plurality of field devices via one or more communication mediums; a computing device comprising: a communication subsystem configured to receive the field device data and the metadata via the one or more communication mediums; a processor; and a non-transitory computer-readable medium having instructions stored thereon that are executable by the processor for causing the processor to perform operations comprising: discovering the plurality of field devices; remotely configuring at least one performance attribute of each field device of the plurality of field devices in an initial calibration process that uses specifications of the plurality of field devices; determining, using at least the metadata, expected performance characteristics of each field device of the plurality of field devices; comparing subsequently received field device data from at least one field device of the plurality of field devices to expected performance characteristics of the at least one field device of the plurality of field devices; and in response to a result of comparing the subsequently received field device data to the expected performance characteristics, outputting a command to cause an action selected from the group consisting of remotely reconfiguring the at least one field device of the plurality of field devices, generating a notification identifying a problem with the at least one field device, and a combination thereof.

Example 2 is the system of example 1, wherein the instructions are executable by the processor for causing the processor to discover new field devices using a device discovery module that is communicatively coupled to the plurality of field devices and positionable to actively scan the system for new field devices.

Example 3 is the system of example 1, wherein the field device data is measurement data.

Example 4 is the system of example 3, wherein the measurement data is selected from the group consisting of pressure, temperature, fluid level, fluid flow rate, vibration, and combinations thereof.

Example 5 is the system of example 1, wherein the metadata includes identifying information about each field device of the plurality of field devices.

Example 6 is the system of example 5, wherein the instructions are executable by the processor for causing the processor to retrieve, using the identifying information, the specifications for each field device of the plurality of field devices from at least one data repository.

Example 7 is the system of example 6, wherein the at least one data repository is selected from the group consisting of a local or remotely located database, a website or other online repository of a manufacturer of the field device, a computer-readable flash memory device, and combinations thereof.

Example 8 is the system of example 1, wherein the computing device is communicatively coupled to an inventory management system, and the instructions are executable by the processor for causing the processor to identify each field device of the plurality of field devices to the inventory management system.

Example 9 is the system of example 1, wherein at least discovery, calibration, and monitoring functions relative to each field device of the plurality of field devices are under centralized control of the computing device.

Example 10 is a non-transitory computer-readable medium comprising instructions that are executable by a processor for causing the processor to: receive, from a communication subsystem, field device data and metadata about a plurality of field devices positioned at a hydrocarbon well location, the field device data and metadata transmitted by the plurality of field devices via one or more communication mediums; discover the plurality of field devices; remotely configure at least one performance attribute of each field device of the plurality of field devices in an initial calibration process that uses specifications of the plurality of field devices; determine, using at least the metadata, expected performance characteristics of each field device of the plurality of field devices; compare subsequently received field device data from at least one field device of the plurality of field devices to expected performance characteristics of the at least one field device of the plurality of field devices; and in response to a result of comparing the subsequently received field device data to the expected performance characteristics, output a command to cause an action selected from the group consisting of remotely reconfiguring the at least one field device of the plurality of field devices, generating a notification identifying a problem with the at least one field device, and a combination thereof.

Example 11 is the non-transitory computer-readable medium of example 10, wherein the field device data is measurement data.

Example 12 is the non-transitory computer-readable medium of example 11, wherein the measurement data is selected from the group consisting of pressure, temperature, fluid level, fluid flow rate, vibration, and combinations thereof.

Example 13 is the non-transitory computer-readable medium of example 10, wherein the metadata includes identifying information about each field device of the plurality of field devices.

Example 14 is the non-transitory computer-readable medium of example 13, wherein the instructions are executable by the processor for causing the processor to retrieve, using the identifying information, the specifications for each field device of the plurality of field devices from at least one data repository.

Example 15 is the non-transitory computer-readable medium of example 14, wherein the at least one data repository is selected from the group consisting of a local or remotely located database, a website or other online repository of a manufacturer of the field device, a computer-readable flash memory device, and combinations thereof.

Example 16 is a method comprising: receiving, by a processor, from a communication subsystem, field device data and metadata about a plurality of field devices positioned at a hydrocarbon well location, the field device data and metadata transmitted by the plurality of field devices via one or more communication mediums; discovering, by the processor, the plurality of field devices; remotely configuring, by the processor, at least one performance attribute of each field device of the plurality of field devices in an initial calibration process that uses specifications of the plurality of field devices; determining, by the processor, using at least the metadata, expected performance characteristics of each field device of the plurality of field devices; comparing, by the processor, subsequently received field device data from at least one field device of the plurality of field devices to expected performance characteristics of the at least one field device of the plurality of field devices; and in response to a result of comparing the subsequently received field device data to the expected performance characteristics, outputting a command, by the processor, to cause an action selected from the group consisting of remotely reconfiguring the at least one field device of the plurality of field devices, generating a notification identifying a problem with the at least one field device, and a combination thereof.

Example 17 is the method of example 16, wherein the field device data is measurement data selected from the group consisting of pressure, temperature, fluid level, fluid flow rate, vibration, and combinations thereof.

Example 18 is the method of example 16, wherein: the metadata includes identifying information about each field device of the plurality of field devices; and the processor retrieves the specifications for each field device of the plurality of field devices from at least one data repository using the at least one identifying characteristic.

Example 19 is the method of example 16, wherein the processor is communicatively coupled to an inventory management system and causes an inventory record of the inventory management system to be updated when a field device is added to or removed from the system.

Example 20 is the method of example 16, further comprising: monitoring operating characteristics of each field device of the plurality of field devices after discovery thereof; and generating a notification upon detection of a problem with at least one field device of the plurality of field devices.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system, comprising:
a plurality of field devices positioned at a hydrocarbon well location, the plurality of field devices positionable to transmit field device data and metadata about the plurality of field devices via one or more communication mediums;
a computing device comprising:
a communication subsystem configured to receive the field device data and the metadata via the one or more communication mediums;
a processor; and
a non-transitory computer-readable medium having instructions stored thereon that are executable by the processor for causing the processor to perform operations comprising:
discovering the plurality of field devices;
remotely configuring at least one performance attribute of each field device of the plurality of field devices in an initial calibration process that uses specifications of the plurality of field devices;
determining, using at least the metadata, expected performance characteristics of each field device of the plurality of field devices;
comparing subsequently received field device data from at least one field device of the plurality of field devices to expected performance characteristics of the at least one field device of the plurality of field devices; and
in response to a result of comparing the subsequently received field device data to the expected performance characteristics, outputting a command to cause an action selected from the group consisting of remotely reconfiguring the at least one field device of the plurality of field devices, generating a notification identifying a problem with the at least one field device, and a combination thereof.

2. The system of claim 1, wherein the instructions are executable by the processor for causing the processor to discover new field devices using a device discovery module that is communicatively coupled to the plurality of field devices and positionable to actively scan the system for new field devices.

3. The system of claim 1, wherein the field device data is measurement data.

4. The system of claim 3, wherein the measurement data is selected from the group consisting of pressure, temperature, fluid level, fluid flow rate, vibration, and combinations thereof.

5. The system of claim 1, wherein the metadata includes identifying information about each field device of the plurality of field devices.

6. The system of claim 5, wherein the instructions are executable by the processor for causing the processor to retrieve, using the identifying information, the specifications for each field device of the plurality of field devices from at least one data repository.

7. The system of claim 6, wherein the at least one data repository is selected from the group consisting of a local or remotely located database, a website or other online repository of a manufacturer of the field device, a computer-readable flash memory device, and combinations thereof.

8. The system of claim 1, wherein the computing device is communicatively coupled to an inventory management system, and the instructions are executable by the processor for causing the processor to identify each field device of the plurality of field devices to the inventory management system.

9. The system of claim 1, wherein at least discovery, calibration, and monitoring functions relative to each field device of the plurality of field devices are under centralized control of the computing device.

10. A non-transitory computer-readable medium comprising instructions that are executable by a processor for causing the processor to:
receive, from a communication subsystem, field device data and metadata about a plurality of field devices positioned at a hydrocarbon well location, the field device data and metadata transmitted by the plurality of field devices via one or more communication mediums;
discover the plurality of field devices;
remotely configure at least one performance attribute of each field device of the plurality of field devices in an initial calibration process that uses specifications of the plurality of field devices;
determine, using at least the metadata, expected performance characteristics of each field device of the plurality of field devices;
compare subsequently received field device data from at least one field device of the plurality of field devices to expected performance characteristics of the at least one field device of the plurality of field devices; and
in response to a result of comparing the subsequently received field device data to the expected performance characteristics, output a command to cause an action selected from the group consisting of remotely reconfiguring the at least one field device of the plurality of field devices, generating a notification identifying a problem with the at least one field device, and a combination thereof.

11. The non-transitory computer-readable medium of claim 10, wherein the field device data is measurement data.

12. The non-transitory computer-readable medium of claim 11, wherein the measurement data is selected from the group consisting of pressure, temperature, fluid level, fluid flow rate, vibration, and combinations thereof.

13. The non-transitory computer-readable medium of claim 10, wherein the metadata includes identifying information about each field device of the plurality of field devices.

14. The non-transitory computer-readable medium of claim 13, wherein the instructions are executable by the processor for causing the processor to retrieve, using the identifying information, the specifications for each field device of the plurality of field devices from at least one data repository.

15. The non-transitory computer-readable medium of claim 14, wherein the at least one data repository is selected from the group consisting of a local or remotely located database, a website or other online repository of a manufacturer of the field device, a computer-readable flash memory device, and combinations thereof.

16. A method comprising:
receiving, by a processor, from a communication subsystem, field device data and metadata about a plurality of field devices positioned at a hydrocarbon well location, the field device data and metadata transmitted by the plurality of field devices via one or more communication mediums;
discovering, by the processor, the plurality of field devices;
remotely configuring, by the processor, at least one performance attribute of each field device of the plurality of field devices in an initial calibration process that uses specifications of the plurality of field devices;
determining, by the processor, using at least the metadata, expected performance characteristics of each field device of the plurality of field devices;
comparing, by the processor, subsequently received field device data from at least one field device of the plurality of field devices to expected performance characteristics of the at least one field device of the plurality of field devices; and
in response to a result of comparing the subsequently received field device data to the expected performance characteristics, outputting a command, by the processor, to cause an action selected from the group consisting of remotely reconfiguring the at least one field device of the plurality of field devices, generating a notification identifying a problem with the at least one field device, and a combination thereof.

17. The method of claim 16, wherein the field device data is measurement data selected from the group consisting of pressure, temperature, fluid level, fluid flow rate, vibration, and combinations thereof.

18. The method of claim 16, wherein:
the metadata includes identifying information about each field device of the plurality of field devices; and
the processor retrieves the specifications for each field device of the plurality of field devices from at least one data repository using the at least one identifying characteristic.

19. The method of claim 16, wherein the processor is communicatively coupled to an inventory management system and causes an inventory record of the inventory management system to be updated when a field device is added to or removed from the system.

20. The method of claim 16, further comprising:
monitoring operating characteristics of each field device of the plurality of field devices after discovery thereof; and
generating a notification upon detection of a problem with at least one field device of the plurality of field devices.
